(19) United States
(12) Patent Application Publication
(10) Pub. No.: US 2019/0218972 A1
(43) Pub. Date: Jul. 18, 2019

(54) THERMALLY PROTECTED THERMOPLASTIC DUCT AND ASSEMBLY

(71) Applicant: General Electric Company, Schenectady, NY (US)

(72) Inventor: Ronald Bruce Schofield, Clarksville, OH (US)

(21) Appl. No.: 15/874,484

(22) Filed: Jan. 18, 2018

(51) Int. Cl. F02C 7/18; F02K 3/06; F01D 25/12; F01D 9/00; F01D 25/26; B32B 1/08; B32B 27/28

(52) U.S. Cl. CPC F02C 7/18; B32B 2262/106; F01D 25/12; F01D 9/00; F01D 25/26; B32B 1/08; B32B 27/288; B32B 27/283; B32B 27/285; F05D 2220/32; F05D 2260/20; F05D 2300/5023; F05D 2300/43; F05D 2300/437; B32B 2597/00; F02K 3/06

(57) ABSTRACT

A cooling apparatus for a gas turbine engine includes a wall structure defining an air flowpath, the wall structure comprising a thermoplastic material; and a thermal barrier layer surrounding the wall structure.

### BACKGROUND OF THE INVENTION

This invention relates generally to gas turbine engines and in particular to flowpath structures such as cooling ducts within a gas turbine engine.

A typical gas turbine engine includes a turbomachinery core having a high-pressure compressor, a combustor, and a high-pressure turbine in serial flow relationship. The core is operable in a known manner to generate a primary gas flow. In practical applications the core is typically combined with other elements such as power turbines, fans, augmentors, etc. to create a useful engine for a specific application, such as turning a propeller, powering an aircraft in flight, or driving a mechanical load.

Generally, within the gas turbine engine several housings used to enclose heat sensitive items, such as ignition exciters and/or other electronics, are positioned in the “under-cowl” area of the gas turbine engine. The temperature in the under-cowl area may reach several hundred degrees Fahrenheit. For example, at the upstream end of the gas turbine engine near the fan, the temperature might be approximately 149° C. (300° F.). Downstream near the combustor and/or turbines, the temperature might be approximately 260° C. to 371° C. (500° F. to 700° F.). These are steady-state operating temperatures. The under-cowl temperatures can be even higher during hot soak conditions after the engine has been shut down, because the source of cooling air has been removed.

As a result, cooling ducts or “blast tubes” have been used to cool the interior of these housings using air from a relatively cool source. For example, fan discharge air for a turbofan engine typically does not exceed 121° C. (250° F.) and may be used for the purpose of cooling. The air may be bled off from the fan by appropriate means such as a scoop or opening, and then channeled through the cooling ducts.

The cooling ducts must have adequate structural strength to support their own weight and any gas pressure loads during operation. The cooling ducts must also have sufficient temperature capability so they do not fail during operation when exposed to relatively high temperatures. Further, the cooling ducts must have sufficient insulating properties so that excessive heat gain from the exterior environment does not enter into the cooling duct, which would heat the air inside and reduce its effectiveness or make it useless for cooling purposes.

One known prior art combination uses a metal duct e.g. stainless steel or nickel, insulated with conventional lagging (insulation) such as a blanket of ceramic fibers which is in turn surrounded by a sheet steel foil barrier. One known brand is sold under the trade name MIN-K. Unfortunately, this combination results in a heavy cooling duct. Another known prior art combination utilizes nonmetallic composite materials such as carbon fibers in an epoxy matrix (inherently temperature resistant). While lighter than the metal duct, it is very expensive to produce.

### BRIEF SUMMARY OF THE INVENTION

At least one of the above-noted problems is addressed by a cooling apparatus formed of a low-temperature capable structural polymeric material surrounded by a thermal barrier material.

According to one aspect of the technology described herein, a cooling apparatus for a gas turbine engine includes a wall structure defining an air flowpath, the wall structure comprising a thermoplastic material; and a thermal barrier layer surrounding the wall structure.

According to another aspect of the technology described herein, a gas turbine engine includes a turbo machinery core surrounded by a casing; a cowling surrounding the casing such that an under-cowl area is defined between the casing and the cowling; and a cooling apparatus disposed in the under-cowl area. The cooling apparatus including a wall structure defining an air flowpath, the wall structure comprising a thermoplastic material; and a thermal barrier layer surrounding the wall structure.

According to another aspect of the technology described herein, a cooling assembly for a gas turbine engine includes an inner tube comprising a thermoplastic material; a housing connected in fluid communication with the inner tube and comprising a thermoplastic material; and a thermal barrier layer surrounding the inner tube and housing

### BRIEF DESCRIPTION OF THE DRAWINGS

The invention may be best understood by reference to the following description taken in conjunction with the accompanying drawing figures in which:

FIG. 1 is a schematic cross-sectional view of a gas turbine engine incorporating an exemplary cooling duct and housing;

FIG. 2 illustrates a two-piece construction of the cooling duct;

FIG. 3 is cross-sectional view of the cooling duct of FIG. 2;

FIG. 4 shows the cooling duct of FIG. 2 with a thermal barrier applied to a connection point after the two pieces are connected;

FIG. 5 is a perspective view of a housing;

FIG. 6 is a view taken along lines 6-6 of FIG. 5; and

FIG. 7 is a cross-sectional view of a cooling duct with an air gap.

### DETAILED DESCRIPTION OF THE INVENTION

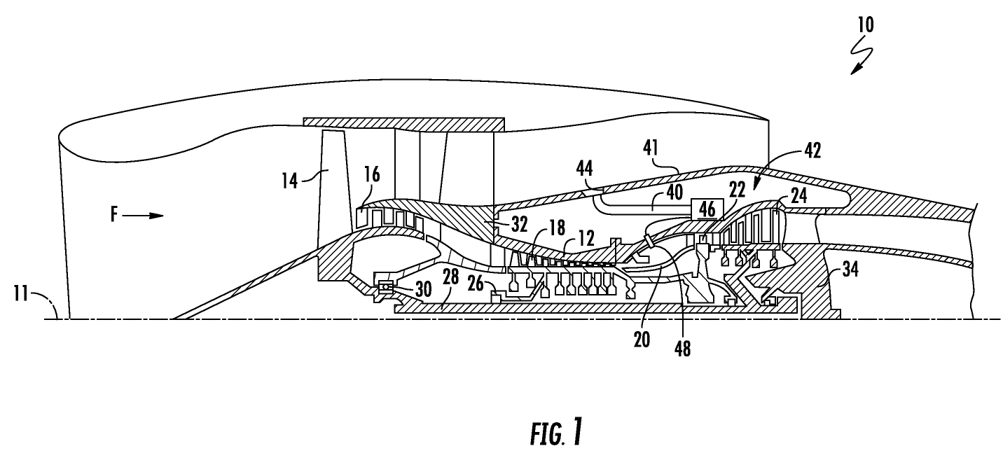

Referring to the drawings wherein identical reference numerals denote the same elements throughout the various views, FIG. 1 depicts a gas turbine engine 10 incorporating a cooling apparatus constructed according to an aspect of the present invention. While the illustrated example is a high-bypass turbofan engine, the principles of the present invention are also applicable to other types of engines, such as low-bypass turbofans, turbojets, stationary gas turbines, etc. The engine 10 has a longitudinal centerline axis 11 and an outer stationary annular casing 12 disposed concentrically about and coaxially along the centerline axis 11. The engine 10 has a fan 14, booster 16, high-pressure compressor 18, combustor 20, high pressure turbine 22, and low-pressure turbine 24 arranged in serial flow relationship. The high-pressure compressor 18, combustor 20, high pressure turbine 22 define a turbomachinery core. In operation, pressurized air from the high-pressure compressor 18 is mixed with fuel in the combustor 20 and ignited, thereby generating combustion gases. Some work is extracted from these gases by the high-pressure turbine 22 which drives the compressor 18 via an outer shaft 26. The combustion gases then flow into the low-pressure turbine 24, which drives the fan 14 and booster 16 via an inner shaft 28. The inner and outer shafts 28 and 26 are rotatably mounted in bearings 30 which are themselves mounted in a fan frame 32 and a turbine rear frame 34.

It is noted that, as used herein, the terms “axial” and “longitudinal” both refer to a direction parallel to the centerline axis 11, while “radial” refers to a direction perpendicular to the axial direction, and “tangential” or “circumferential” refers to a direction mutually perpendicular to the axial and radial directions. As used herein, the terms “forward” or “front” refer to a location relatively upstream in an air flow passing through or around a component, and the terms “aft” or “rear” refer to a location relatively downstream in an air flow passing through or around a component. The direction of this flow is shown by the arrow “F” in FIG. 1. These directional terms are used merely for convenience in description and do not require a particular orientation of the structures described thereby.

A core cowl 41 surrounds the casing 12, thereby defining an under-cowl area 42. As shown, the cooling duct 40 is positioned in the under-cowl area 42 and is connected between opening 44 and housing 46 to provide cooling air to the housing 46. The housing 46 contains heat sensitive components and/or electronics. For example, the housing 46 may contain an ignition exciter (not shown) used to power an igniter 48 for the gas turbine engine's 10 combustor 20. As illustrated, the cooling duct 40 is in the form of a tubular duct having a circular cross-section; however, it should be appreciated that other suitable cross-sectional shapes may be used. Individually and collectively, the cooling duct 40 and the housing 46 are example of “cooling apparatus” as that term is used herein.

The opening 44 allows cooling air to be bled off from the fan 14. It should be appreciated that other air diverting structures such as a scoop may be used in combination with the opening 44 to divert the cooling air into the cooling duct 40. Once the cooling air is directed into the cooling duct 40, the air is directed into an interior of the housing 46 to maintain a suitable temperature therein. For example, in some applications, it may be desirable to maintain a temperature of about 120° C. (250° F.).

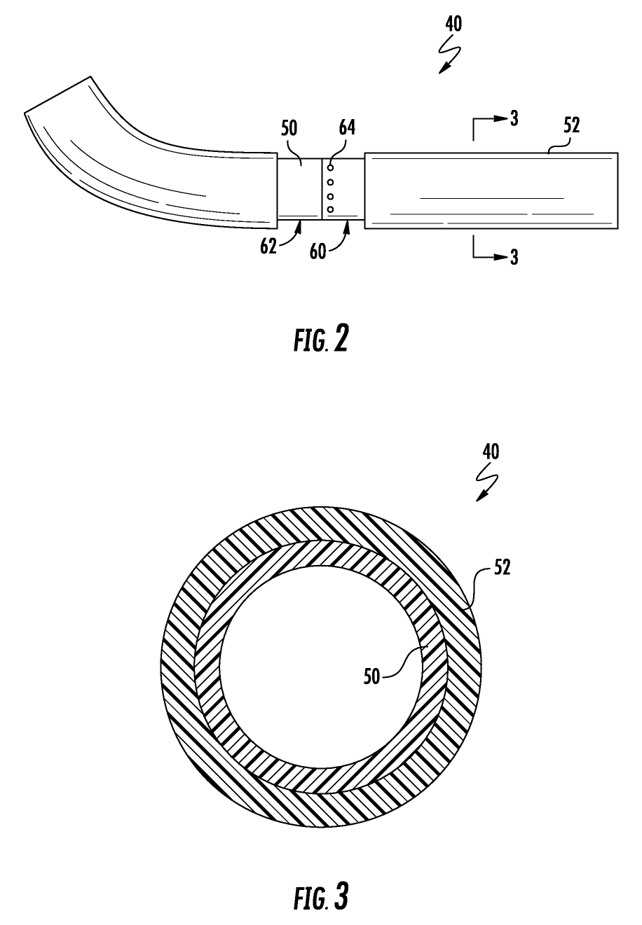

Referring to FIGS. 2 and 3, the cooling duct 40 includes an inner tube 50 formed of a structurally sufficient but low-temperature capable polymeric material which is surrounded by a thermal barrier 52 (e.g. insulating layer). Nonlimiting examples of suitable thermoplastics include polyether ether ketone (“PEEK”), polyphenylene sulfide (“PPS”), or polyetherimide (“PEI”). PEI is commercially available under the trade name ULTEM. Optionally, the inner tube 50 may be formed of a thermoplastic composite (i.e. reinforcing fibers in a thermoplastic matrix). The matrix may be one of the thermoplastic polymers listed above. Nonlimiting examples of suitable reinforcing fibers include glass fibers and carbon fibers. One nonlimiting example of a suitable composite system includes carbon fiber fabric (sold commercially under the trade name “AS-4”) cured in a matrix of polyether ether ketone (“PEEK”). Temperature capability of such a composite is approximately 177° C. (350° F.). Such a construction results in a cooling duct 40 that is lighter than metal and less expensive than a carbon fiber-epoxy composite. The polymeric material may also be un-reinforced. The inner tube 50 is an example of a wall structure which defines an air flowpath. As used herein, the term “air flowpath” refers to a volume which is bounded at least in part by a structure effective to contain or guide an air flow. Such a flowpath may be open or may be partially or wholly closed.

The thermal barrier 52 protects inner tube 50 from temperatures exceeding the temperature capability of the polymeric material from which the inner tube 50 is constructed. One suitable material is a silicone-based material. Silicones, also known as polysiloxanes, are polymers that include any inert, synthetic compound made up of repeating units of siloxane, which is a chain of alternating silicon atoms and oxygen atoms, frequently combined with carbon and/or hydrogen.

The thermal barrier 52 may be a homogeneous, unreinforced material. The thermal barrier 52 may be applied to the inner tube 50 by wrapping sheets of the thermal barrier 52 around the inner tube 50 and then adhering the thermal barrier to the inner tube 50 using an adhesive such as a room temperature vulcanizing (“RTV”) silicone material. The thermal barrier 52 may also be sprayed on in a wet state. Optionally, as shown in FIG. 7, spacers 58 may be used to create an air gap 56 between the thermal barrier 52 and the inner tube 50.

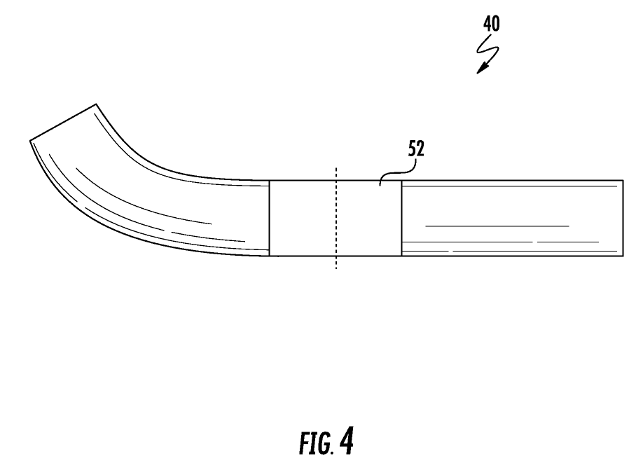

The polymeric material allows the inner tube 50 to be formed into any suitable flow path and/or shape. As illustrated in FIG. 2, the inner tube 50 is formed of a first linear tube section 60 and a second curved tube section 62 interconnected by fasteners 64. Inner tube 50 may alternatively be of a unitary construction. In the case of a multi-section inner tube 50, the thermal barrier 52 may be applied onto the first and second tube sections 60 and 62 prior to being interconnected, thereby leaving a section of the wall structure 50 without thermal barrier 52, FIG. 2, or applied after the first and second tube sections 60 and 62 have been connected together. In the event the thermal barrier 52 is applied prior to connection, the thermal barrier 52 may be applied over the bare inner tube 50 section where the first and second tube sections 60 and 62 are connected together after connecting the first and second tube sections 60, 62, as shown in FIG. 4.

As an example, the inner tube 50 may have a diameter of approximately 7.62 cm to 10.16 cm (3 to 4 inches). The thermal barrier 52 may be very thin. For example, for the same 8 cm to 10 cm (3 to 4 inch) diameter tube, the wall thickness of the thermal barrier 52 might be in the range of about 10 mils (0.01 inches) to about 150 mils (0.150 inches).

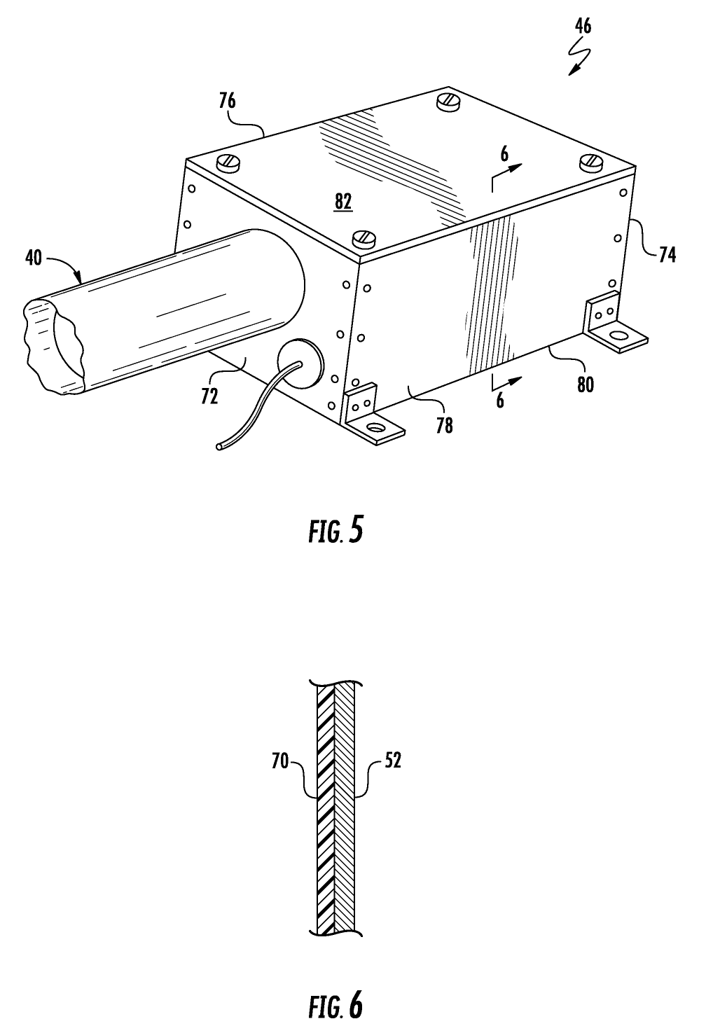

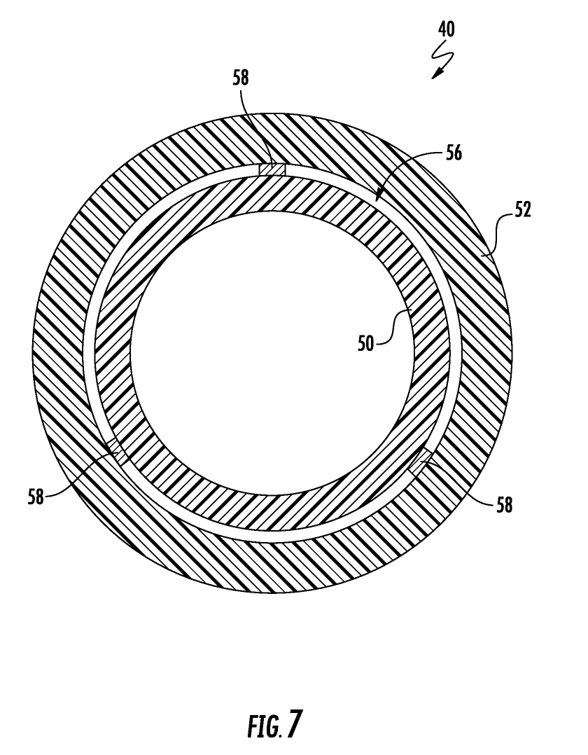

As discussed above, the cooling duct 40 may be connected to housing 46 to supply cooling air to the housing 46. Typically, in the prior art, housings like housing 46 are constructed of metal and then an insulating material is attached thereto. As shown in FIGS. 5 and 6, housing 46 may also be constructed using the same technique as described with respect to the cooling duct 40. More particularly, the housing 46 may include an inner housing 70 having a plurality of panels defining a front 72, a rear 74, a left side 76, a right side 78, a bottom 80, and a top 82. As illustrated, the inner housing 70 is constructed completely out of the polymeric material described above; however, it should be appreciated that a mix of materials may be used to construct the inner housing 70. For example, the front 72, rear 74, left side 76, right side 78, and bottom 80 may be constructed of the polymeric material while the top 82 is constructed of metal. The inner housing 70 is an example of a wall structure which defines an air flowpath.

Once the inner housing 70 is constructed, the thermal barrier 52 may be applied to the inner housing 70 to insulate the inner housing 70 from excess temperatures above the temperature capability of the polymeric material. It should be appreciated that the cooling duct 40 and housing 46 may be assembled prior to installation in the under-cowl area 42. It should also be appreciated that the inner tube 50 may be connected to the inner housing 70 prior to applying the thermal barrier 52. Once the inner tube 50 and inner housing 70 have been connected into an assembly, the thermal barrier 52 may be applied to the entire assembly at one time.

The foregoing has described a thermally protected thermoplastic duct and assembly for a gas turbine engine. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A cooling apparatus for a gas turbine engine, comprising:
a wall structure defining an air flowpath, the wall structure comprising a thermoplastic material; and
a thermal barrier layer surrounding the wall structure.

2. The apparatus of claim 1 wherein the wall structure is a tube.

3. The apparatus of claim 1 wherein the wall structure is a housing including a plurality of panels.

4. The apparatus of claim 1 wherein the thermal barrier layer contacts an outer surface of the wall structure.

5. The apparatus of claim 1 wherein the thermal barrier layer is spaced from the wall structure to define an air gap therebetween.

6. The apparatus of claim 1 wherein the wall structure is a thermoplastic composite.

7. The apparatus of claim 6 wherein the thermoplastic composite includes carbon fibers cured in a matrix of polyether ether ketone.

8. The apparatus of claim 1 wherein the thermoplastic material comprises polyether ether ketone.

9. The apparatus of claim 1 wherein the thermal barrier layer is a silicone-based material.

10. The apparatus of claim 9 wherein the thermal barrier layer is in the form of one or more sheets wrapped around the wall structure.

11. A gas turbine engine, comprising:
a turbomachinery core surrounded by a casing;
a cowling surrounding the casing such that an under-cowl area is defined between the casing and the cowling; and
a cooling apparatus disposed in the under-cowl area, comprising:
a wall structure defining an air flowpath, the wall structure comprising a thermoplastic material; and
a thermal barrier layer surrounding the wall structure.

12. The gas turbine engine of claim 11, wherein the cooling apparatus is in fluid communication with an opening in the cowling to receive cooling air from a fan of the gas turbine engine.

13. The gas turbine engine of claim 11 wherein the cooling apparatus includes a tube.

14. The gas turbine engine of claim 11 wherein the cooling apparatus includes a housing including a plurality of panels.

15. The gas turbine engine of claim 11 wherein the wall structure is a thermoplastic composite having carbon fibers cured in a matrix of polyether ether ketone.

16. The gas turbine engine of claim 11 wherein the thermal barrier layer is a silicone-based material.

17. A cooling apparatus for a gas turbine engine, comprising:
an inner tube comprising a thermoplastic material;
a housing, including a plurality of panels, the housing connected in fluid communication with the inner tube and comprising a thermoplastic material; and
a thermal barrier layer surrounding the inner tube and housing.

18. The apparatus of claim 17 wherein the thermoplastic composite having carbon fibers cured in a matrix of polyether ether ketone.

19. The apparatus of claim 17 wherein the thermal barrier layer is a silicone-based material.

20. The apparatus of claim 17 wherein the thermal barrier layer is in contact with an outer surface of the inner tube and an outer surface of the housing.
